(19) United States
(12) Patent Application Publication
(10) Pub. No.: US 2005/0153806 A1
(43) Pub. Date: Jul. 14, 2005

(54) Rotating device

(75) Inventor: Ta Sheng Huang, Miao Li Hsien (TW)

Correspondence Address: Ladas & Parry, 26 West 61st Street, New York, NY, 10023, US

(73) Assignee: HENG TONG TECHNOLOGY CO., LTD.

(21) Appl. No.: 10/771,995

(22) Filed: Feb. 4, 2004

Related U.S. Application Data
(63) Continuation of application No. 10/756,693, filed on Jan. 12, 2004, now abandoned.

(51) Int. Cl. F16H 7/00

(52) U.S. Cl. 474/84

(57) ABSTRACT

The invention relates to a rotating device. The rotating device comprises: a transmitting assembly, a plate and a plurality of binding elements. The transmitting assembly has at least one first transmitting element, a second transmitting element and at least one third transmitting element. Each transmitting element has a plurality of movable sections and fixed sections. The transmitting elements are connected in parallel at the fixed section. The second transmitting element is disposed between the first transmitting element and the third transmitting element. The plate is circularly forced by the second transmitting element. The binding elements are mounted on the first transmitting elements and the third transmitting elements in pairs to bind the movable section. The transmitting assembly has a first portion and a second portion. The movable sections of the first portion of the transmitting assembly are not bound by the binding elements. The movable sections of the second portion of the transmitting assembly are bound by the binding elements. Therefore, the total weight of the second portion is higher than that of the first portion. The plate is circularly forced toward to the second portion. The rotating device of the invention does not need any energy, and utilizes the binding elements to bind the movable sections at a suitable area, and the bound movable sections are at the second portion. The binding elements release the bound movable sections at another area so that the movable sections are not bound at the first portion. Under the rotation of the plate, the binding elements can exactly bind and release the movable sections so that the total weight of the second portion is eternally higher than that of the first portion. The plate is circularly forced toward to the second portion, and rotates eternally.

### BACKGROUND OF THE INVENTION

1. Field of the Invention

The present invention relates to a rotating device.

2. Description of the Related Art

In view of the law of conservation of energy, energy cannot be produced or destroyed. Therefore, to make a device rotate, energy must be input higher than the friction. In no input-energy situation, gravity, spring and magnet are often considered to use as energy sources to rotate a device. However, without any input energy or special mechanic design, the energy from gravity, spring and magnet cannot rotate a device eternally.

Accordingly, many inventors still endeavor to develop a device that can rotate eternally, but the energy sources are still gravity, spring and magnet. Based on gravity, spring and magnet, many special mechanic structures are tried to be designed to obtain the object of rotating a device eternally. However, there has been no successful case as of now.

Therefore, it is necessary to provide an innovative and progressive rotating device so as to obtain the object of rotating a device eternally.

### SUMMARY OF THE INVENTION

One objective of the present invention is to provide a rotating device. The rotating device comprises: a transmitting assembly, a plate and a plurality of binding elements. The transmitting assembly has at least one first transmitting element, a second transmitting element and at least one third transmitting element. Each transmitting element has a plurality of movable sections and fixed sections. The transmitting elements are connected in parallel at the fixed sections. The second transmitting element is disposed between the first transmitting element and the third transmitting element. The plate is circularly forced by the second transmitting element. The binding elements are mounted on the first transmitting elements and the third transmitting elements in pairs to bind the movable section.

The transmitting assembly has a first portion and a second portion. The movable sections of the first portion of the transmitting assembly are not bound by the binding elements. The movable sections of the second portion of the transmitting assembly are bound by the binding elements. Therefore, the total weight of the second portion is higher than that of the first portion. The plate is circularly forced toward to the second portion.

The rotating device of the invention does not need any energy, and utilizes the binding elements to bind the movable sections at a suitable area, and the bound movable sections are at the second portion. The binding elements release the bound movable sections in another area so that the movable sections are not bound in the first portion. Under the rotation of the plate, the binding elements can exactly bind and release the movable sections so that the total weight of the second portion is eternally higher than that of the first portion. The plate is circularly forced toward to the second portion, and rotates eternally.

### BRIEF DESCRIPTION OF THE DRAWINGS

FIG. 1 shows the structure of the rotating device, according to the invention;

FIG. 2 is an enlarged partial perspective view showing a chain assembly of the rotating device, according to the invention;

FIG. 3 shows that the binding element is hooking in the movable section, according to the invention;

FIG. 4 shows that the binding element has hooked in the movable section, according to the invention;

FIG. 5 shows that the binding element binds the movable sections, according to the invention;

FIG. 6 shows that the binding element will be off the movable section, according to the invention;

FIG. 7 shows that the binding element has been off the movable section, according to the invention; and

FIG. 8 is a perspective view showing a plate of the rotating device, according to the invention.

### DETAILED DESCRIPTION OF THE INVENTION

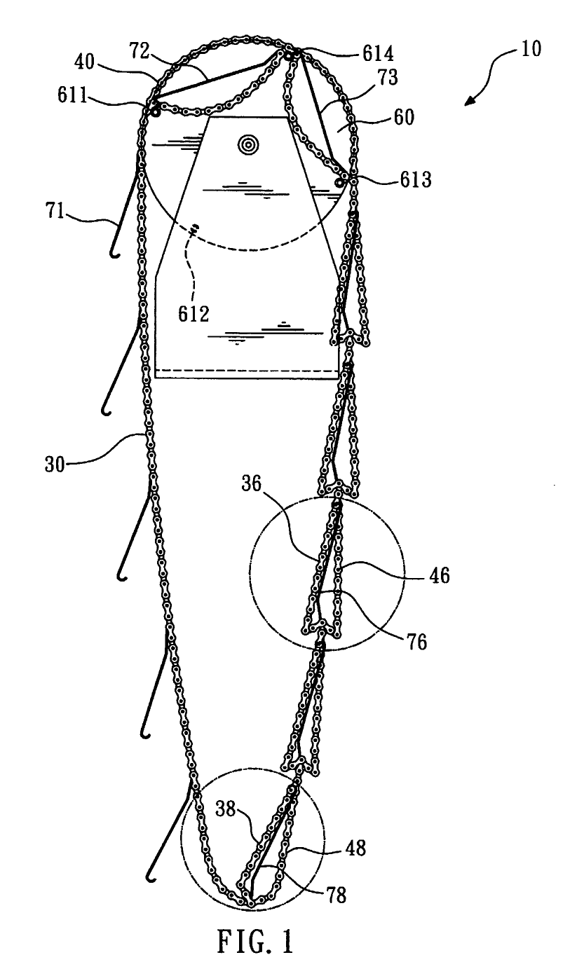

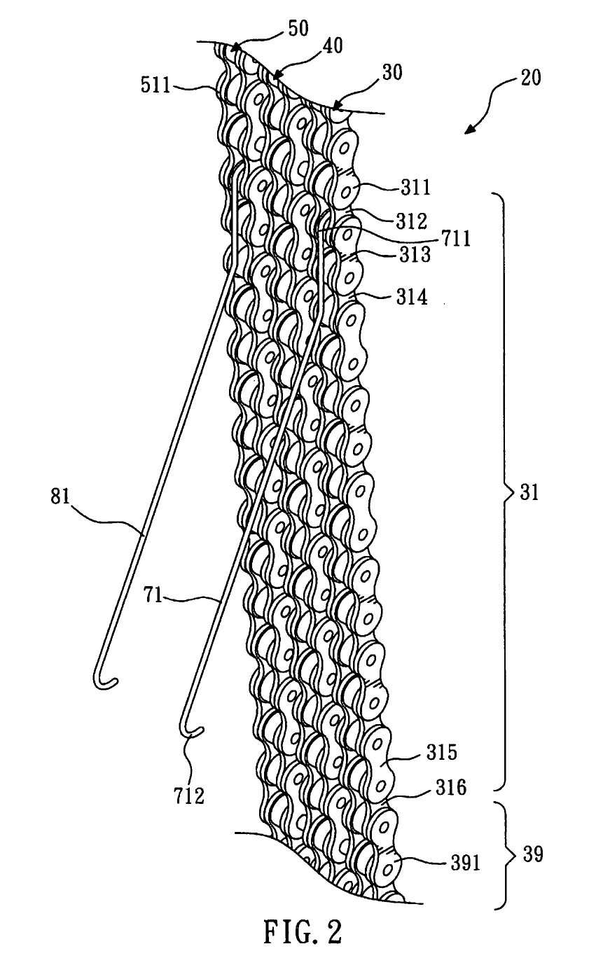

Referring to FIG. 1, according to the invention, a rotating device 10 comprises: a transmitting assembly 20 (referring to FIG. 2), a plate 60 and a plurality of binding elements 71, 72, 73, 74 and 75. The transmitting assembly 20 has at least one first transmitting element (for example a first chain 30), a second transmitting element (for example a second chain 40) and at least one third transmitting element (for example a third chain 50). Each transmitting element has a plurality of movable sections and fixed sections. The transmitting elements are connected in parallel at the fixed section. The second transmitting element is disposed between the first transmitting element and the third transmitting element.

Referring to FIG. 2, the transmitting assembly 20 is a chain assembly. The chain assembly 20 has at least one first chain 30, a second chain 40 and at least one third chain 50. Each chain 30, 40, 50 has a plurality of movable sections and fixed sections. In the embodiment of the invention, each chain 30, 40, 50 has twelve areas. The first area 31 and the twelfth area 39 of the first chain 30 are taken as examples. The first area 31 of the first chain 30 has a fixed section 311. At the fixed section 311, the first chain 30, the second chain 40 and the third chain 50 are connected in parallel by a fixed pin to form the chain assembly 20. There are movable sections 312, 313, 314, 315 and 316 between the fixed section 311 of the first area 31 and the fixed section 391 of the twelfth area 39. The movable sections 312, 313, 314, 315 and 316 of the first chain 30 are not connected with the second chain 40 and the third chain 50, and are freely movable. The second chain 40 is disposed between the first chain 30 and the third chain 50.

In the embodiment of the invention, the binding elements 71 and 81 (referring to FIG. 2) are hooks mounted on the first chain 30 and the third chain 50 in pairs, respectively. The binding element 71 is taken as an example. The binding element 71 has two ends. One end 711 is fixed on a movable section 312 (next to the fixed section 311) and the other end 712 of the binding element 71 is formed as a hooked shape. The length of the binding element 71 is shorter than the length between two fixed sections 311 and 391.

In FIG. 2, the binding element 71 is not bound to the movable sections 312, 313, 314, 315 and 316. Referring to FIG. 1 again, in a left portion of the chain assembly 20, the binding elements (71 etc.,) are not bound to the movable sections of the chain assembly 20. In a right portion of the chain assembly 20, the binding elements (76, 78, etc.,) are bound to the movable sections of the chain assembly 20. Therefore, the total weight of the right portion is eternally higher than that of the left portion. The plate is circularly forced toward the right portion in clockwise direction.

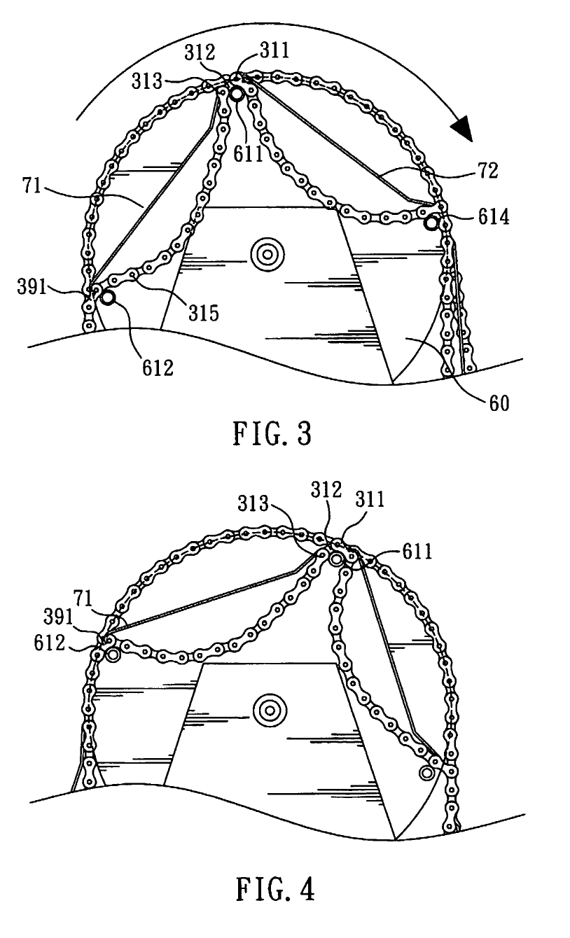

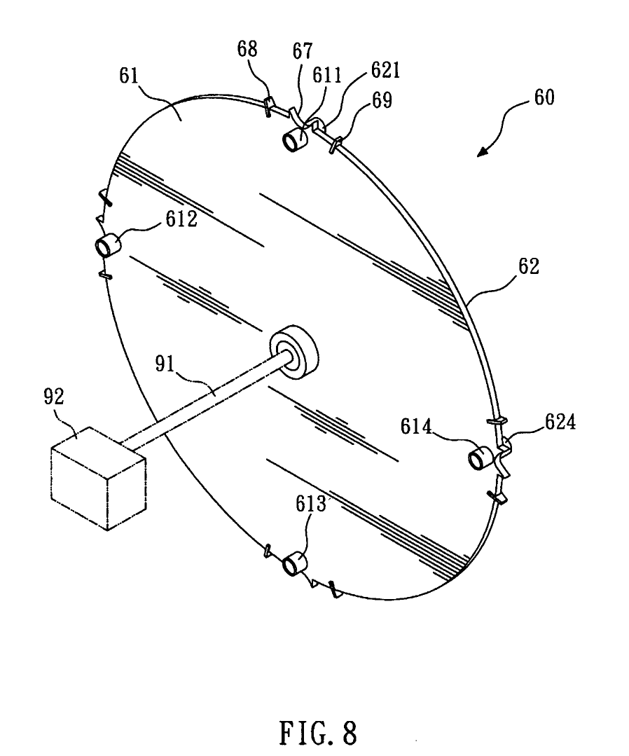

FIG. 3 describes how to bind the movable sections by the binding element. Referring to FIGS. 2 and 3, given the above, the second chain 40 is disposed between the first chain 30 and the third chain 50, and at the fixed section 311, the first chain 30, the second chain 40 and the third chain 50 are connected in parallel. The movable sections are freely movable. The plate 60 is circularly forced by the second chain 40. There are four supporting protrusions 611, 612, 613 and 614 formed on the first surface 61, and the supporting protrusions 611, 612, 613 and 614 are averagely mounted on the edge of the first surface 61 (referring to FIG. 8). The distance between the two supporting protrusions 611 and 612, and the number of the fixed section 311 and the movable sections 312, 313, 314, 315 and 316 are precisely calculated to match each other so that the two supporting protrusions 611 and 612 on the first surface 61 can support the two fixed sections 311 and 391, respectively.

The movable sections 312, 313, 314, 315 and 316 of the first chain 30 are not connected with the second chain 40 and the third chain 50, but are hung between two fixed sections 311 and 391 as a circle. As mentioned above, the length of the binding element 71 is shorter than the length between the two fixed sections 311 and 391. When the first area 31 of the first chain 30 is hung as a circle, the hooked shape end 712 of the binding element 71 can hook in the movable section 316 (before the fixed section 391). Referring to FIG. 4, under the rotation of the plate 60 in the clockwise direction, the hooked shape end 712 of the binding element 71 smoothly hooks the movable section 316. After the hooked shape end 712 of the binding element 71 hooks the movable section 316, the hooked situation is held until the hooked shape end 712 reaches the lowest portion of the first chain 30.

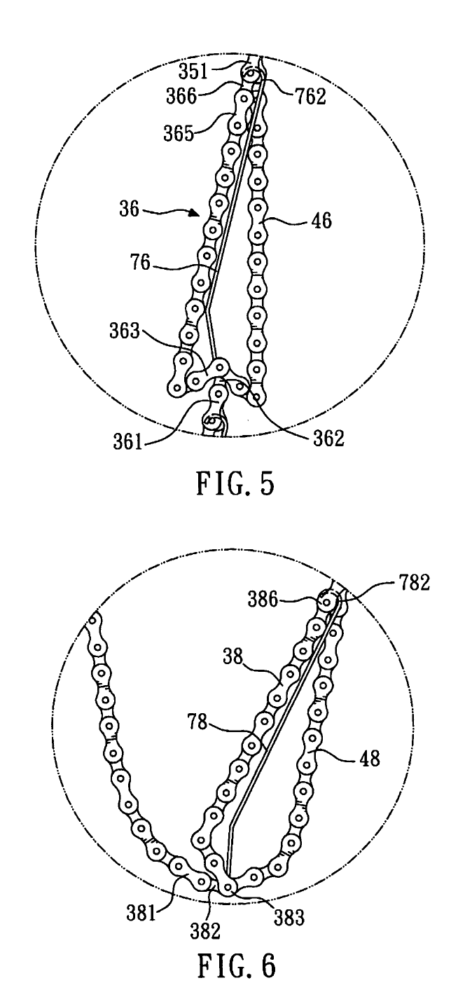

Referring to FIG. 5, it shows that the binding element binds the movable sections. The sixth area 36 of the first chain 30 and the sixth area 46 of the second chain 40 are taken as examples. As stated in the above, the hooked shape end 762 of the binding element 76 hooks the movable section 366, and the length of the binding element 76 is shorter than the length of the bound movable section 362, 363, 365 and 366. Besides, the binding element 76 has an oblique angle with the first chain 30. Therefore, the movable sections 362, 363, 365 and 366 of the sixth area 36 are bound by the binding element 76, and folded as shown in FIG. 5.

Furthermore, the sixth area 46 of the second chain 40 is not restrained by the binding element 76. However, because the first chain 30 and the second chain 40 are connected at the fixed sections 361 and 351, the movable sections of the sixth area 46 of the second chain 40 are folded as shown in FIG. 5. The bound situation of the third chain 50 is the same as that of the first chain 30, but is not shown in FIG. 5.

Referring to FIGS. 1 and 5, in a right portion of the chain assembly 20, the binding elements (76, 78, etc.,) are bound to the movable sections of the chain assembly 20 so that the total numbers of the fixed sections and the movable sections in the right portion are larger than those of the fixed sections and the movable sections in the left portion (at the ratio of about 120:100). Therefore, the total weight of the right portion is eternally higher than that of the left portion. The plate 60 is circularly forced toward to the right portion in clockwise direction.

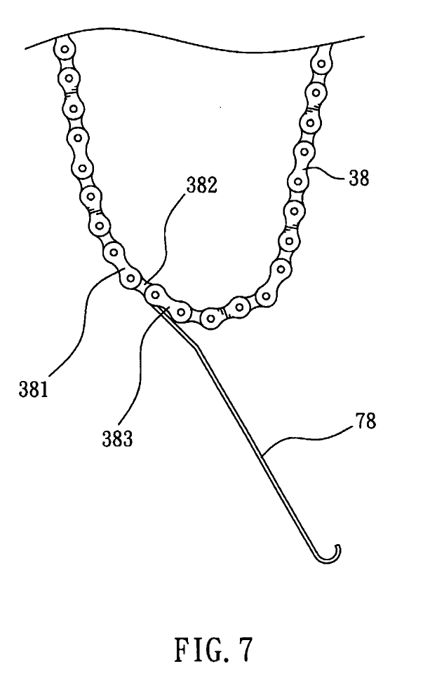

Referring to FIGS. 6 and 7, they show that the binding element automatically releases the bound situation. The eighth area 38 of the first chain 30 and the eighth area 48 of the second chain 40 are explained as follows. The movable sections 382, 383 and 386 of the eighth area 38 of the first chain 30 are bound by the binding element 78, and the eighth area 38 is at the lowest area of the first chain 30. Because of the bending rate and the force of the movable section 382, 383 and 386, the hooked shape end 782 of the binding element 78 is releasing from the movable section 386. Under the rotation of the chain assembly 20, the hooked shape end 782 of the binding element 78 will be released from the movable section 386, and the bound movable sections of the eighth area 38 of the first chain 30 are released. Therefore, in the left portion of the chain assembly, the binding elements do not bind the movable sections.

Referring to FIG. 8, the plate 60 comprises a first surface 61 and a second surface 62. The second surface 62 corresponds to the first surface 61. There are four supporting protrusions 611, 612, 613 and 614 on the first surface 61, and similarly there are four supporting protrusions 621 and 624 (the others are not shown in FIG. 8). The supporting protrusions 611, 612, 613 and 614 on the first surface 61 are used to support the fixed sections of the first chain 30, and the supporting protrusions 621 and 624 on the second surface 62 are used to support the fixed sections of the third chain 50. The plate further comprises a plurality of pins 67, 68 and 69 to receive the movable section of the second chain 40 so that the plate 60 is forced by the second chain 40. The plate 60 further comprises a shaft 91 mounted at the center of the plate 60. The shaft 91 of the plate 60 connected to a coupling device 92. The coupling device 92 can output the energy of the rotation of the shaft 91.

The chain assembly of the invention is not limited to three chains, and the numbers of the fixed sections and the movable sections are not limited in the above embodiment. The middle chain of the chain assembly is used to force the plate, and the numbers of the chain on the left side and on the right side must be equal so as to balance. The shape of the plate is not limited as a circle. The shape and the length of the binding element are not restrained as stated in the above embodiment.

The rotating device of the invention does not need any energy, and utilizes the binding elements to bind the movable sections at a suitable area (the plate 60 in the embodiment), and the bound movable sections are at the second portion (the right portion in the embodiment). The binding elements release the bound movable sections in another area (the lowest portion of the chain assembly in the embodiment) so that the movable sections are not bound at the first portion (the left portion in the embodiment). Under the rotation of the plate, the binding elements can exactly bind and release the movable sections so that the total weight of the second portion is eternally higher than that of the first portion. The plate is circularly forced toward to the second portion, and rotates eternally.

While an embodiment of the present invention has been illustrated and described, various modifications and improvements can be made by those skilled in the art. The embodiment of the present invention is therefore described in an illustrative but not restrictive sense. It is intended that the present invention may not be limited to the particular forms as illustrated, and that all modifications which maintain the spirit and scope of the present invention are within the scope as defined in the appended claims.

1. A rotating device, comprising:
a transmitting assembly, having at least one first transmitting element, a second transmitting element and at least one third transmitting element, each transmitting elements having a plurality of movable sections and fixed sections, the transmitting elements connected in parallel at the fixed sections, the second transmitting element disposed between the first transmitting element and the third transmitting element;
a plate, forced by the second transmitting element; and
a plurality of binding elements, mounted on the first transmitting elements and the third transmitting elements in pairs to bind the movable section;
thereby the transmitting assembly having a first portion and a second portion, the movable section of the first portion of the transmitting assembly not bound by the binding elements, the movable section of the second portion of the transmitting assembly bound by the binding elements, the total weight of the second portion being higher than that of the first portion, and the plate rotating toward to the second portion.

2. The rotating device according to claim 1, wherein the transmitting assembly is a chain assembly, the chain assembly having at least one first chain, a second chain and at least one third chain, each chain having a plurality of movable section and fixed sections, the chains connected in parallel at the fixed section, and the second chain disposed between the first chain and the third chain.

3. The rotating device according to claim 2, wherein the plate has a first surface, a second surface and a plurality of pins, the pins are used to receive the movable section of the second chain so that the plate is forced by the second chain, and each of the first surface and the second surface has a plurality of supporting protrusions spaced from each other.

4. The rotating device according to claim 3, wherein the binding elements are hooks mounted on the first chain and the third chain in pairs, each hook has two ends, one end is fixed on a movable section, and the other end of the hook is hook-shaped to hook another movable section so that the movable sections are bound by the hook.

5. The rotating device according to claim 4, wherein the length of the hook is shorter than the length between two fixed sections.

6. The rotating device according to claim 4, wherein each hook has an oblique angle with the first chain and the third chain.

7. The rotating device according to claim 3, wherein four supporting protrusions are formed on the first surface and the second surface respectively, and the supporting protrusions are spaced-equally mounted on the edge of the first surface and the second surface.

8. The rotating device according to claim 3, wherein the supporting protrusions on the first surface are used to support the fixed section of the first chain, and the supporting protrusions on the second surface are used to support the fixed section of the third chain.

9. The rotating device according to claim 1, wherein the plate further comprises a shaft mounted on the center of the plate.

10. The rotating device according to claim 9, further comprising a coupling device connected to the shaft of the plate.
